(19) United States
(12) Patent Application Publication
(10) Pub. No.: US 2026/0330709 A1
(43) Pub. Date: Oct. 22, 2026

(54) AGRICULTURAL MAPPING AND RELATED DEVICES, SYSTEMS, AND METHODS

(71) Applicant: Ag Leader Technology, Ames, IA (US)

(72) Inventors: Andrew Gurik, Ames, IA (US); Mike Skyberg, Maxwell, IA (US); Tiffany Sperry, Ankeny, IA (US)

(21) Appl. No.: 19/468,873

(22) Filed: Feb. 3, 2026

Related U.S. Application Data
(60) Provisional application No. 63/753,201, filed on Feb. 3, 2025.

(51) Int. Cl. G06T 11/10; A01B 79/00; G06T 15/00

(52) U.S. Cl. CPC G06T 11/10; A01B 79/005; G06T 15/005; G06T 2200/24

(57) ABSTRACT

An agricultural mapping system that computes per-feature display colors on a graphics processing unit (GPU) at render time based on raw feature data and a parameterized legend definition provided to a shader via uniforms. In response to user edits to the legend—such as changes to bin boundaries, color ramps, opacity, normalization, classification mode, or no-data behavior—the system updates uniform values without rebuilding CPU-side color buffers or reloading geometry/data to the GPU, thereby re-rendering maps immediately with revised colors. The approach supports quantized and continuous gradients, optional one-dimensional color lookup textures, and heterogeneous feature types including polygons, lines, rasters, and points, and can be implemented across common graphics APIs. The system operates on an in-cab agricultural display having a GUI and GPU to enable real-time interaction during field operations, and may receive legend definitions or updates from remote or cloud services.

### CROSS-REFERENCE TO RELATED APPLICATION(S)

This application claims the benefit under 35 U.S.C. § 119(e) to U.S. Provisional Application 63/753,201, filed Feb. 3, 2025, and entitled Agricultural Mapping and Related Devices, Systems, and Methods, which is hereby incorporated herein by reference in its entirety for all purposes.

### TECHNICAL FIELD

The disclosure relates to agricultural mapping, displays, data processing and technical improvement to the functioning thereof.

### BACKGROUND

The ability to change a legend can be a costly for the processing components of an agricultural display. Additionally, prior known systems that allow for changing the legend may be slowsza, cause display lockup and/or missed polygons (sections of the map). This is undesirable and causes poor user experience.

### BRIEF SUMMARY

Disclosed herein are various methods, devices, and systems for changing map legend color attributes. The disclosed technical improvements to the functioning of the system components include decoupling data and color representation, use of GLSL (OpenGL Shading Language) uniforms, and optionally GPU (Graphics Processing Unit) offloading.

In Example 1, a computer-implemented method for changing map legend color attributes in a digital mapping display, comprising loading, into a graphics processing unit (GPU), geometry for a plurality of map features and raw per-feature data values associated with the plurality of map features, executing, on the GPU, a shader program configured to compute a display color based on the raw per-feature data values and a legend definition provided to the shader program as one or more shader uniforms, and responsive to a user modification of the legend definition, updating the one or more shader uniforms without modifying the geometry or the raw per-feature data values resident on the GPU, and re-rendering the plurality of map features with updated colors computed by the shader program.

Example 2 relates to the method of any of Examples 1 and 3-8, wherein the digital mapping display is an agricultural operations display configured to render agricultural maps during field operations.

Example 3 relates to the method of any of Examples 1-2 and 4-8, wherein the raw per-feature data values comprise at least one of: yield, moisture, application rate, or prescription class.

Example 4 relates to the method of any of Examples 1-3 and 5-8, further comprising presenting a graphical user interface (GUI) configured to receive the user modification of the legend definition and to trigger in-place updates to the one or more shader uniforms.

Example 5 relates to the method of any of Examples 1-4 and 6-8, wherein the geometry comprises polygons representing at least one of fields, management zones, and application passes.

Example 6 relates to the method of any of Examples 1-5 and 7-8, wherein the shader program is executed under at least one of OpenGL, OpenGL ES, WebGL, Vulkan, Metal, Direct3D, or WebGPU.

Example 7 relates to the method of any of Examples 1-6 and 8, wherein the re-rendering occurs without rebuilding per-vertex or per-polygon color buffers on a central processing unit (CPU).

Example 8 relates to the method of any of Examples 1-7, wherein the legend definition is received from a remote server or cloud service and applied via uniform updates to the shader program.

In Example 9, a system comprising one or more processors and a GPU configured to execute a graphics API supporting programmable shaders, a display device configured to present a map view of a plurality of map features, a memory storing geometry for the plurality of map features and raw per-feature data values, and a shader program executable by the GPU and configured to compute display colors for the plurality of map features based on the raw per-feature data values and a legend definition received as one or more shader uniforms, wherein the system is configured to, responsive to a user modification of the legend definition, update the one or more shader uniforms without modifying the geometry or the raw per-feature data values resident on the GPU and re-render the plurality of map features with updated colors computed by the shader program.

Example 10 relates to the system of any of Examples 9 and 11-14, further comprising a user interface module configured to receive user input modifying one or more of color ramps, breakpoints, classification type, thresholds, category-to-color mappings, opacity, or no-data behavior and update corresponding shader uniform values used by the shader program.

Example 11 relates to the system of any of Examples 9-10 and 12-14, wherein the display device comprises an in-cab agricultural display configured to present yield, moisture, and application rate maps with the display colors computed by the shader program.

Example 12 relates to the system of any of Examples 9-11 and 13-14, wherein the GPU is configured to compute the display colors in a fragment shader using normalized raw per-feature data values and a color ramp defined by the legend definition.

Example 13 relates to the system of any of Examples 9-12 and 14, wherein the raw per-feature data values are updated in real-time or near real-time during field operation, and color mapping for the plurality of map features is recomputed by the shader program without CPU-side color buffer generation.

Example 14 relates to the system of any of Examples 9-13, wherein the shader program applies different no-data behaviors for different data layers rendered concurrently in the map view.

In Example 15, a non-transitory computer-readable medium storing instructions that, when executed by one or more processors in communication with a GPU, cause the one or more processors to: load, to the GPU, geometry for a plurality of map features and raw per-feature data values associated with the plurality of map features; initiate execution of a shader program configured to compute display colors based on the raw per-feature data values and a legend definition provided as one or more shader uniforms; and responsive to receiving a user modification to the legend definition, update the one or more shader uniforms without modifying the geometry or the raw per-feature data values resident on the GPU, and trigger re-rendering of the plurality of map features with updated colors computed by the shader program.

Example 16 relates to the non-transitory computer-readable medium of any of Examples 15 and 17-20, wherein the legend definition comprises at least one of bin boundaries, color values, a color lookup table, interpolation parameters, opacity values, normalization factors, or no-data behavior.

Example 17 relates to the non-transitory computer-readable medium of any of Examples 15-16 and 18-20, wherein the instructions further cause the one or more processors to normalize the raw per-feature data values according to parameters specified in the legend definition and to pass the normalized values to the shader program.

Example 18 relates to the non-transitory computer-readable medium of any of Examples 15-17 and 19-20, wherein the geometry comprises polygons representing at least one of fields, management zones, and application passes.

Example 19 relates to the non-transitory computer-readable medium of any of Examples 15-18 and 20, wherein the instructions further cause the one or more processors to render polygons, linework, raster tiles, or point clouds for agricultural maps on an agricultural operations display, wherein the display colors are computed at render time using the shader program.

Example 20 relates to the non-transitory computer-readable medium of any of Examples 15-19, wherein the shader program is implemented using GLSL, and the one or more shader uniforms comprise at least one of scalar uniforms, vector uniforms, array uniforms, or uniform buffer objects.

A system of one or more computers or computing devices can be configured to perform particular operations or actions by virtue of having software, firmware, hardware, or a combination of them installed on the system that in operation causes the system to perform the actions. One or more computer programs can be configured to perform particular operations or actions by virtue of including instructions that, when executed by data processing apparatus, cause the apparatus to perform the actions.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a diagram of a harvester implementing the system, according to one implementation.

FIG. 2 is a system diagram, according to one implementation.

FIG. 3 is a diagram showing execution of various steps of the system, according to one implementation.

### DETAILED DESCRIPTION

Described herein are methods, devices, and system for changing map legend color attributes. The disclosure relates to agricultural mapping and the ability to change/modify the map legend for better visualization. The following detailed description illustrates representative implementations for efficiently changing map legend color attributes in digital mapping systems, including agricultural mapping displays with polygon-dense datasets. The described methods, devices, and systems enable near real-time legend modification without rebuilding per-vertex or per-polygon color buffers on the CPU by offloading color evaluation to a GPU shader that receives raw data values and a legend definition as shader uniforms.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sept. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. Pat. No. 12,353,210, issued Jul. 8, 2025, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. Pat. No. 12,268,115, issued Apr. 8, 2025, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. Pat. No. 12,414,505, issued Sep. 16, 2025, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/556,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. Pat. No. 12,403,950, issued Sep. 2, 2025, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/766,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. patent application Ser. No. 18/974,482, filed Dec. 9, 2024, entitled “Header Height Control Devices, Systems and Methods,” U.S. patent application Ser. No. 18/980,728, filed Dec. 13, 2024, entitled “Deck Plate Spacing Sensors and Related Devices, Systems, and Methods,” U.S. patent application Ser. No. 19/041,787, filed Jan. 30, 2025, entitled “Grain Cart Unloading Sensor and Unload Control System and Associated Devices and Methods,” U.S. patent application Ser. No. 19/207,115, filed May 13, 2025, entitled “Devices, Systems, and Methods for Planter and Seed Trench Imaging and Analysis,” U.S. patent application Ser. No. 19/219,718, fled May 27, 2025, entitled “Devices, Systems, and Methods for Agricultural Navigation and Positioning,” U.S. patent application Ser. No. 19/226,004, filed Jun. 2, 2025, entitled “Devices, Systems, and Methods for Machinery Monitoring and Reporting,” U.S. Patent Application 63/667,546, filed Jul. 3, 2024, entitled “Cover for Port Openings,” U.S. patent application Ser. No. 19/260,159, filed Jul. 3, 2025, entitled “Agricultural Seed Meters and Related Devices, Systems and Methods,” U.S. patent application Ser. No. 19/297,963, filed Aug. 12, 2025, entitled “Agricultural Navigation and Steering Systems, Devices and Methods,” U.S. patent application Ser. No. 19/305,530, filed Aug. 20, 2025, entitled “Crop Sensor Wands and Related Devices, Systems, and Methods,” U.S. patent application Ser. No. 19/366,202, filed Oct. 22, 2025, entitled “Crop Sensors and Related Devices, Systems, and Methods,” U.S. patent application Ser. No. 19/367,363, filed Oct. 23, 2025, entitled “Agricultural Sprayer Sensor and Related Devices, Systems, and Methods,” U.S. patent application Ser. No. 19/390,280, filed Nov. 14, 2025, entitled “Liquid Product Distribution for Agricultural Spraying Systems and Related Devices and Methods,” U.S. patent application Ser. No. 19/396,047, filed Nov. 20, 2025, entitled “Agricultural Harvesting Systems and Related Devices and Methods,” U.S. patent application Ser. No. 19/396,099, filed Nov. 20, 2025, entitled “Sprayer Nozzle Devices and Related Systems and Methods,” U.S. patent application Ser. No. 19/397,422, filed Nov. 21, 2025, entitled “Systems, Methods, and Devices for Increasing Machine Operating Range,” U.S. patent application Ser. No. 19/408,177, filed Dec. 3, 2025, entitled “Agricultural Guidance and Navigation System and Related Devices and Methods,” U.S. patent application Ser. No. 19/467,539, filed Feb. 2, 2026, entitled “System and Automatic Adjustment to Target Pressure and Related Devices and Methods,” U.S. patent application Ser. No. 19/467,588, filed Feb. 2, 2026, entitled “Harvester Liquid Application System, Devices, and Methods,” U.S. Patent Application 63/753,258, filed Feb. 3, 2025, entitled “Agricultural Navigation Methods, Devices, and Systems,” U.S. Patent Application 63/755,675, filed Feb. 7, 2025, entitled “Remote Assistance for Agricultural Display Methods and Related Devices and Systems,” U.S. Patent Application 63/757,242, filed Feb. 11, 2025, entitled “Seed Meter,” U.S. Patent Application 63/757,434, filed Feb. 12, 2025, entitled “Grain Fill Sensor,” U.S. Patent Application 63/760,907, filed Feb. 20, 2025, entitled Agricultural Yield Monitoring and Estimation Devices, Systems, and Methods,” U.S. Patent Application 63/816,284, filed Jun. 2, 2025, entitled “Agricultural Guidance and Navigation Systems, Methods, and Devices,” U.S. Patent Application 63/817,692, filed Jun. 4, 2025, entitled “Intelligent Steering System for Sprayers and Tractors in Standing Crops,” U.S. Patent Application 63/818,248, filed Jun. 5, 2025, entitled “Devices, Systems, and Methods for Determining Implement Pose,” U.S. Patent Application 63/906,692, filed Oct. 28, 2025, entitled “Agricultural Alignment System and Related Devices and Methods,” U.S. Patent Application 63/906,646, filed Oct. 28, 2025, entitled “Automated Grail Filling System and Related Devices and Methods,” U.S. Patent Application 63/967,084, filed Jan. 23, 2025, entitled “System and Methods of Row-by-Row Yield Monitoring,” U.S. Patent Application 63/966,976, filed Jan. 23, 2025, entitled “Dispatch Indicator Calibration,” and U.S. Patent Application 63/967,038, filed Jan. 23, 2025, entitled “Grain Fill Sensor and Related Devices, Systems, and Methods,” each of which is incorporated herein by reference.

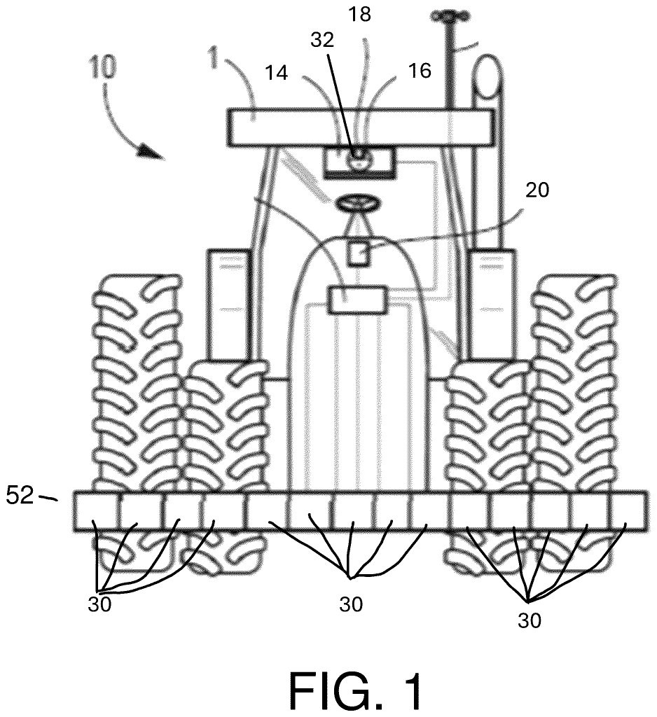

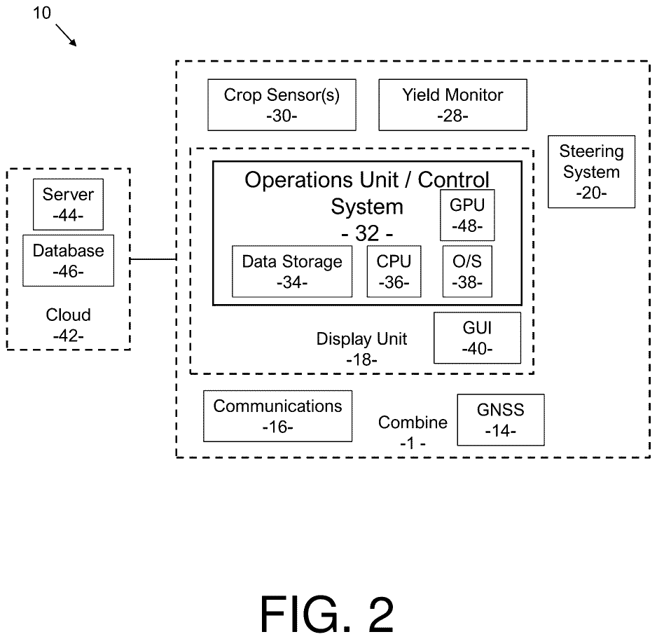

Turning to the figures in more detail, in various implementations the mapping system 10 is implemented on a combine 1, planter 1 or other agricultural vehicle, as would be understood, shown in FIG. 1. In various implementations, the system 10 includes a GNSS or GPS receiver 14 in operational communication with a vehicle system display 18, such as the InCommand® display from Ag Leader®, and an operations unit 32, as is shown in greater detail in FIG. 2. The system 10 optionally comprises various additional sensors, monitors and the like, as would be appreciated by those of skill in the art and as disclosed in various of the incorporated references.

The system 10 further includes an automatic and/or assisted steering system 20. As would be understood, various automatic and/or assisted steering systems 20 are configured to take inputs from an operations unit 32 navigate a vehicle through a field. Various steering systems 20 may manually and/or electronically manipulate the systems on board a harvest vehicle 1 to effectuate automatic and/or assisted steering, as would be appreciated by those of skill in the art. In various implementations, the automatic/assisted steering system 20 allows for autonomous navigation.

Continuing with FIGS. 1 and 2, in various implementations, the system 10 includes an operations unit 32, optionally integrated within the display, in operational communication with data link 16 (also referred to herein as a communications component 16). It is generally understood that these components may optionally be housed within the display unit 18 and that the representation of FIG. 2 is merely exemplary.

In certain implementations, the operations unit 32 is also configured for the sending and receiving of data for storage and processing, such as to the cloud 42, a remote server 44, database 46, and/or other cloud computing components readily understood in the art. Such connections by the operations unit 32, can be made wirelessly via understood internet and/or cellular technologies such as Bluetooth, Wi-Fi, LTE, 3G, 4G, or 5G connections, and the like. It is understood that in certain implementations, the operations unit 32 and/or cloud 42 component may comprise encryption or other data privacy components such as hardware, software, and/or firmware security aspects.

Continuing with FIG. 2, the operations unit 32, according to certain implementations, further has one or more optional processing and computing components, such as data storage 34, a CPU or processor 36, an operating system (“O/S”) 38, and other computing components necessary for implementing the various technologies disclosed herein. It is appreciated that the various optional system components are in operational communication with one another via wired or wireless connections and are configured to perform the processes and execute the commands described herein. As would be understood, each of these components can be located optionally at various locations around the vehicle or elsewhere, such as in the cloud 42 and accessible by a wireless or cellular connection.

In various implementations, this connectivity means that an operator, enterprise manager, and/or other third party is able to receive notifications such as adjustment prompts and confirmation screens on their mobile devices or via another access point. In certain implementations, these individuals can review the various data collected or recorded by the system 10 and make adjustments, comments, and/or observations in real-time or near real-time, as would be readily appreciated.

In conventional systems, changing a map legend requires recomputing color buffers on the CPU and retransferring these buffers to the GPU for rendering, which becomes costly when rendering many polygons and large datasets. In various implementations described herein, color assignment is decoupled from geometry and computed in the fragment and/or vertex shader based on raw per-feature data and a configurable legend supplied via one or more shader uniforms. This approach avoids rebuilding color buffers on legend changes and leverages GPU parallelism for color mapping at render time.

One implementation of the system 10 includes one or more processors 36 and a GPU 48 configured to execute a graphics API supporting programmable shaders (e.g., OpenGL ES, WebGL, OpenGL, Vulkan, Metal with analogous uniform/buffer constructs). The system 10 also include a display device 18, such as an agricultural guidance or operations display, mobile device, or desktop system. The system 10 also includes a map rendering pipeline that accepts polygon geometry (e.g., fields, management zones, application passes) and per-feature or per-vertex raw data values (e.g., yield, moisture, rate, prescription class). The system 10 may also include a shader program comprising a vertex shader and fragment shader.

In various implementations, the shader program is configured to receive: raw data values in a vertex attribute or per-instance attribute, or via a GPU buffer (e.g., vertex buffer object (VBO), instance buffer, shader storage buffer object (SSBO) in supporting APIs). The shader may also receive a legend definition communicated using shader uniforms (e.g., uniform scalars, vectors, arrays, uniform buffer objects (UBOs) where available). The legend definition can include bin boundaries, color lookup tables, interpolation parameters, opacity values, nodata behaviors, and scaling factors.

In various implementations, the system 10 also includes a user interface 40 module that allows a user to change legend parameters (e.g., color ramps, breakpoints, dynamic range, classification type, thresholds, and category-to-color mappings) and triggers an in-place update of uniform values without modifying the underlying vertex/geometry buffers.

In an exemplary implementations, map features are represented as polygons with indices referencing geometry buffers residing on the GPU 48. Associated with each polygon is at least one raw scalar value V representing a measurement or classification.

In this and other implementations, legend parameters are encoded via uniforms, for example ______. In other implementations, legends may be encoded in a 1D color lookup texture whose coordinates are derived from normalized V. The uniform then includes a sampler and normalization parameters, allowing high-resolution ramps and dynamic reconfiguration by changing the sampler binding or normalization range without altering geometry buffers.

The separation of raw data and legend parameters allows legend changes to be executed by updating uniform values only. The geometry buffers and raw data buffers remain unchanged and resident on the GPU, eliminating repeated CPU-side color computation and memory transfers.

In a representative method, the system 10 and various processing components, discussed above, operate by executing a series of steps. As would be understood, each step is optional and may be performed in any order or not at all. Various steps may be performed sequentially, iteratively, and/or simultaneously.

In a first optional step, the system 10 loads geometry buffers for polygons onto the GPU 48. The system 10 may then load raw per-polygon or per-vertex data values to a GPU-accessible buffer or attribute.

In another optional step, a shader program configured to compute color per-fragment based on the raw value and legend uniforms is initialized. In another step, the initial legend is set by writing uniform arrays and parameters (breakpoints, colors, mapping mode, no data handling).

In a further optional step, the system 10 renders the map by drawing the polygons; the shader computes the color for each fragment based on current uniform legend parameters and raw data V.

In a further optional step, upon user changes to the legend (e.g., altering color ramp, updating thresholds, switching between quantized and continuous modes), the system 10 updates only the corresponding uniform values.

In another optional step, the system 10 executes a further optional step to re-render using the same geometry and raw data buffers; and the updated uniform legend drives new color results without CPU-side buffer rebuilds.

The described approach improves performance of the system 10 and processing components in a number of way. One way is by avoiding CPU-bound color buffer re-computation when the legend changes; only uniform updates are performed, which are small and efficient to transmit to the GPU. Another performance improvement is due to exploiting GPU parallelism for per-fragment color mapping, which scales effectively with large numbers of polygons and high-resolution displays. The system 10 further improves functioning by reducing UI latency that would otherwise occur from rebuilding and uploading large color arrays, enabling responsive interactive legend editing even in dense agricultural maps. Further, oOn devices with constrained resources, uniform updates are typically orders of magnitude smaller than full color buffer re-uploads. The described technique also mitigates UI stalls and frame drops that can lead to missed polygon draws or unresponsive controls in legacy pipelines that block during buffer rebuilds.

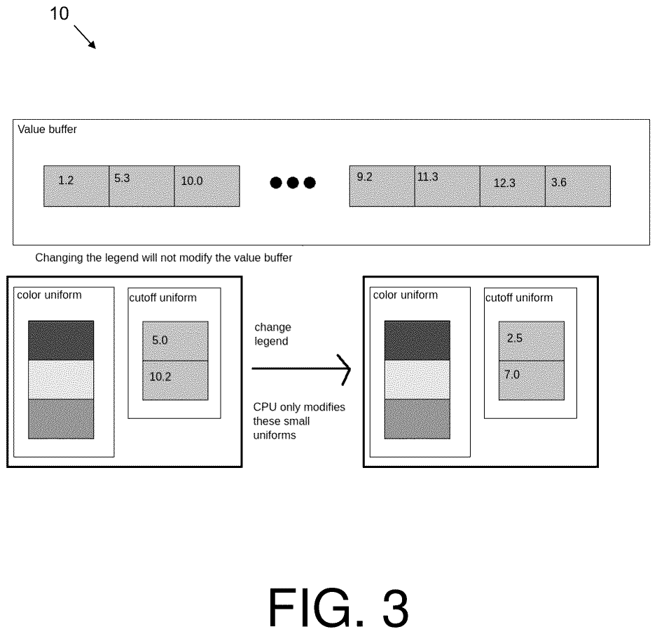

In agricultural operation displays rendering yield, moisture, and/or application rate maps with thousands of polygons, users frequently change classification thresholds to inspect different operating conditions. Using the described system, the user can: switch between a five-class quantized legend and a continuous gradient without altering geometry buffers; adjust breakpoints to refine class boundaries for field-specific conditions; change color ramps (e.g., from green-to-red to blue-to-yellow) via uniform updates; and define nodata display behavior for non-sampled regions to a distinct hatch or color via a dedicated uniform, shown for example in FIG. 3.

These interactions occur without blocking the main UI thread for buffer rebuilds and without triggering large GPU uploads beyond uniform changes, yielding smooth visual feedback during analysis and preventing missed draws during navigation, panning, or zooming.

In one example of the system 10 described herein changes in color attributes are implemented by passing raw data values to a GPU through a buffer and making the shader program decode those values using a legend in the form of a GLSL uniform. A GLSL uniform being a global variable in a shader program that acts as a parameter for the user. Uniforms are named for their consistent value across shader invocations during a rendering call. This vastly improves the time required to re-color a map when modifying a legend. By encoding the legend as a uniform in the GLSL shader, real-time adjustments to the color mapping are enabled without modifying the underlying data or geometry. This is very efficient because uniforms are relatively lightweight compared to sending entire new color buffers.

Although examples reference GLSL uniforms, analogous constructs in other shading languages and APIs can be employed, including constant buffers in HLSL/Direct3D, argument buffers in Metal, descriptor sets in Vulkan, and uniform-like mechanisms in WebGPU WGSL. Similarly, while examples focus on polygonal agricultural maps, the approach applies to raster tiles, point clouds, and line work when color depends on per-feature or per-fragment data values.

As described herein the disclosed system improves the performance of the processing components and advantages including: a substantial reduction in CPU time associated with legend changes by avoiding color buffer re-computation; lower latency and improved responsiveness in the UI when modifying map styling, particularly for polygon-dense datasets; more robust rendering under heavy interaction, mitigating stalls that can cause missed draw events on prior systems; and enhanced user experience through immediate visual feedback, encouraging exploration and adjustment of map legends to better understand operations.

The system 10 can be implemented on embedded displays 18, mobile devices, or desktops using a graphics API with shader programmability. The CPU 36 hosts the GUI 40 and issues uniform updates in response to user input. The GPU 48 executes shaders to compute per-fragment colors using the current legend. Storage media 34 (non-volatile memory) contains program instructions that when executed cause the system 10 to perform the methods described, including uploading raw data, configuring uniform legend parameters, and rendering.

Although the disclosure has been described with references to various embodiments, persons skilled in the art will recognize that changes may be made in form and detail without departing from the spirit and scope of this disclosure.

What is claimed is:

1. A computer-implemented method for changing map legend color attributes in a digital mapping display, comprising:
loading, into a graphics processing unit (GPU), geometry for a plurality of map features and raw per-feature data values associated with the plurality of map features;
executing, on the GPU, a shader program configured to compute a display color based on the raw per-feature data values and a legend definition provided to the shader program as one or more shader uniforms; and
responsive to a user modification of the legend definition, updating the one or more shader uniforms without modifying the geometry or the raw per-feature data values resident on the GPU, and re-rendering the plurality of map features with updated colors computed by the shader program.

2. The method of claim 1, wherein the digital mapping display is an agricultural operations display configured to render agricultural maps during field operations.

3. The method of claim 1, wherein the raw per-feature data values comprise at least one of: yield, moisture, application rate, or prescription class.

4. The method of claim 1, further comprising presenting a graphical user interface (GUI) configured to receive the user modification of the legend definition and to trigger in-place updates to the one or more shader uniforms.

5. The method of claim 1, wherein the geometry comprises polygons representing at least one of fields, management zones, and application passes.

6. The method of claim 1, wherein the shader program is executed under at least one of OpenGL, OpenGL ES, WebGL, Vulkan, Metal, Direct3D, or WebGPU.

7. The method of claim 1, wherein the re-rendering occurs without rebuilding per-vertex or per-polygon color buffers on a central processing unit (CPU).

8. The method of claim 1, wherein the legend definition is received from a remote server or cloud service and applied via uniform updates to the shader program.

9. A system comprising:
(a) one or more processors and a GPU configured to execute a graphics API supporting programmable shaders;
(b) a display device configured to present a map view of a plurality of map features;
(c) a memory storing geometry for the plurality of map features and raw per-feature data values; and
(d) a shader program executable by the GPU and configured to compute display colors for the plurality of map features based on the raw per-feature data values and a legend definition received as one or more shader uniforms,
wherein the system is configured to, responsive to a user modification of the legend definition, update the one or more shader uniforms without modifying the geometry or the raw per-feature data values resident on the GPU and re-render the plurality of map features with updated colors computed by the shader program.

10. The system of claim 9, further comprising a user interface module configured to:
receive user input modifying one or more of color ramps, breakpoints, classification type, thresholds, category-to-color mappings, opacity, or no-data behavior; and
update corresponding shader uniform values used by the shader program.

11. The system of claim 9, wherein the display device comprises an in-cab agricultural display configured to present yield, moisture, and application rate maps with the display colors computed by the shader program.

12. The system of claim 9, wherein the GPU is configured to compute the display colors in a fragment shader using normalized raw per-feature data values and a color ramp defined by the legend definition.

13. The system of claim 9, wherein the raw per-feature data values are updated in real-time or near real-time during field operation, and color mapping for the plurality of map features is recomputed by the shader program without CPU-side color buffer generation.

14. The system of claim 9, wherein the shader program applies different no-data behaviors for different data layers rendered concurrently in the map view.

15. A non-transitory computer-readable medium storing instructions that, when executed by one or more processors in communication with a GPU, cause the one or more processors to:
load, to the GPU, geometry for a plurality of map features and raw per-feature data values associated with the plurality of map features;
initiate execution of a shader program configured to compute display colors based on the raw per-feature data values and a legend definition provided as one or more shader uniforms; and
responsive to receiving a user modification to the legend definition, update the one or more shader uniforms without modifying the geometry or the raw per-feature data values resident on the GPU, and trigger re-rendering of the plurality of map features with updated colors computed by the shader program.

16. The non-transitory computer-readable medium of claim 15, wherein the legend definition comprises at least one of bin boundaries, color values, a color lookup table, interpolation parameters, opacity values, normalization factors, or no-data behavior.

17. The non-transitory computer-readable medium of claim 15, wherein the instructions further cause the one or more processors to normalize the raw per-feature data values according to parameters specified in the legend definition and to pass the normalized values to the shader program.

18. The non-transitory computer-readable medium of claim 15, wherein the geometry comprises polygons representing at least one of fields, management zones, and application passes.

19. The non-transitory computer-readable medium of claim 15, wherein the instructions further cause the one or more processors to render polygons, linework, raster tiles, or point clouds for agricultural maps on an agricultural operations display, wherein the display colors are computed at render time using the shader program.

20. The non-transitory computer-readable medium of claim 15, wherein the shader program is implemented using GLSL, and the one or more shader uniforms comprise at least one of scalar uniforms, vector uniforms, array uniforms, or uniform buffer objects.
